(19) United States
(12) Patent Application Publication
(10) Pub. No.: US 2025/0316199 A1
(43) Pub. Date: Oct. 9, 2025

(54) DISPLAY DEVICE FOR ADJUSTING DISPLAY BRIGHTNESS AND BRIGHTNESS CONTROL METHOD THEREFOR

(71) Applicant: SAMSUNG ELECTRONICS CO, LTD., Suwon-si (KR)

(72) Inventors: Sein OH, Suwon-si (KR); Youngkook KIM, Suwon-si (KR); Jung HUR, Suwon-si (KR)

(73) Assignee: SAMSUNG ELECTRONICS CO, LTD., Suwon-si (KR)

(21) Appl. No.: 19/242,531

(22) Filed: Jun. 18, 2025

Related U.S. Application Data
(63) Continuation of application No. PCT/KR2023/016493, filed on Oct. 23, 2023.

(30) Foreign Application Priority Data
Dec. 19, 2022 (KR) 10-2022-0178714

(51) Int. Cl. G09G 3/20

(52) U.S. Cl. CPC G09G 3/20; G09G 2320/0626; G09G 2360/144; G09G 2360/16

(57) ABSTRACT

A display device includes a display and an illuminance sensor. The display device obtains an illuminance value through the illuminance sensor, identifies a representative illuminance value corresponding to the time at which the illuminance value is obtained among the plurality of representative illuminance values for each time stored in the memory. The display device, based on a difference between the obtained illuminance value and the identified representative illuminance value being greater than or equal to a preset threshold value, obtains another illuminance value through the illuminance sensor and compares the another illuminance value to the identified representative illuminance value. The display device, based on a difference between each illuminance value of the plurality of illuminance values obtained a preset number of times and the identified representative illuminance value being greater than or equal to the preset threshold value, controls a brightness of the display.

### CROSS-REFERENCE TO RELATED APPLICATIONS

This application is a continuation application of International Application No. PCT/KR2023/016493, filed on Oct. 23, 2023, which claims priority to Korean Patent Application No. 10-2022-0178714, filed on Dec. 19, 2022, in the Korean Intellectual Property Office, the disclosures of which are incorporated by reference herein in their entireties.

### BACKGROUND

### 1. Field

The disclosure relates to a display device for adjusting display brightness and a brightness control method therefor.

### 2. Description of Related Art

A display device is a device that displays an image on a screen such as a TV or a monitor. Recently, there are many cases that a display device having a large screen is installed outdoors or outside.

A brightness of a display may need to be adjusted according to a surrounding environment in that the display device is installed outdoors.

### SUMMARY

According to an aspect of the disclosure, there is provided a display device including: a display; an illuminance sensor; memory that stores at least one instruction, information about a plurality of illuminance values obtained at each time during a plurality of dates, and a plurality of representative illuminance values obtained based on the plurality of illuminance values obtained at each time; and one or more processors configured, wherein the at least one instruction, when executed by the one or more processors, cause the display device to: obtain an illuminance value through the illuminance sensor; identify a representative illuminance value corresponding to the time at which the illuminance value is obtained among the plurality of representative illuminance values for each time stored in the memory; based on a difference between the obtained illuminance value and the identified representative illuminance value being greater than or equal to a preset threshold value, obtain another illuminance value through the illuminance sensor and compare the another illuminance value to the identified representative illuminance value; and based on a difference between each illuminance value of the plurality of illuminance values obtained a preset number of times and the identified representative illuminance value being greater than or equal to the preset threshold value, control a brightness of the display based on the identified representative illuminance value.

The at least one instruction, when executed by the one or more processors, may cause the display device to: cluster the plurality of illuminance values obtained at each time as at least one cluster based on the plurality of illuminance values obtained at each time; identify the representative illuminance value corresponding to each cluster based on the plurality of illuminance values included in each cluster of the at least one cluster corresponding to each time; and store the identified representative illuminance value in the memory.

The at least one instruction, when executed by the one or more processors, may cause the display device to: apply a weight value based on a date when each illuminance value of the plurality of illuminance values included in each cluster is obtained to each illuminance value of the plurality of illuminance values included in each cluster; identify the representative illuminance value corresponding to each cluster based on the plurality of illuminance values to which the weight value applies; and apply a larger weight value to the illuminance value obtained on a later date among the plurality of dates.

The at least one instruction, when executed by the one or more processors, may cause the display device to: obtain an arithmetic mean of the plurality of illuminance values to which the weight value applies and identify the representative illuminance value corresponding to each cluster.

The display may include: a communication interface, wherein the at least one instruction, when executed by the one or more processors, may cause the display device to: based on a difference between each illuminance value of the plurality of illuminance values obtained the preset number of times and the identified representative illuminance value being greater than or equal to the preset threshold value, transmit an alarm related to the illuminance sensor to an electronic device through the communication interface.

The at least one instruction, when executed by the one or more processors, may cause the display device to: based on a difference between the obtained illuminance value and the identified representative illuminance value being smaller than the preset threshold value, control the brightness of the display based on the obtained illuminance value.

The at least one instruction, when executed by the one or more processors, may cause the display device to: based on a difference between the obtained illuminance value and the identified representative illuminance value being smaller than the preset threshold value, delete the illuminance value obtained on a fastest date among the plurality of illuminance values obtained at a same time as a present time when the illuminance value is obtained through the illuminance sensor during the plurality of dates from the memory, store the illuminance value obtained through the illuminance sensor in the memory, and update the plurality of illuminance values corresponding to the time when the illuminance value is obtained through the illuminance sensor.

The at least one instruction, when executed by the one or more processors, may cause the display device to: identify the representative illuminance value based on the updated plurality of illuminance values and store the identified representative illuminance value in the memory.

According to an aspect of the disclosure, there is provided a method of controlling a brightness of a display device including a display, an illuminance sensor, and memory, the method including: obtaining an illuminance value through the illuminance sensor; identifying a representative illuminance value corresponding to a time at which the illuminance value is obtained among representative illuminance values for each time stored in the memory; based on a difference between the obtained illuminance value and the identified representative illuminance value being greater than or equal to a preset threshold value, obtaining another illuminance value through the illuminance sensor and comparing the another illuminance value to the identified representative illuminance value; and based on a difference between each illuminance value of a plurality of illuminance values obtained a preset number of times and the identified representative illuminance value being greater than or equal to the preset threshold value, controlling the brightness of the display based on the identified representative illuminance value, wherein the representative illuminance values for each time stored in the memory may be values identified based on the plurality of illuminance values obtained for each time during a plurality of dates.

The method may further include: clustering the plurality of illuminance values obtained at each time as at least one cluster based on the plurality of illuminance values obtained at each time; identifying the representative illuminance value corresponding to each cluster based on the plurality of illuminance values included in each cluster of the at least one cluster corresponding to each time; and storing the identified representative illuminance value in the memory.

The identifying corresponding to each cluster may include: applying a weight value based on a date when each illuminance value of the plurality of illuminance values included in each cluster is obtained to each illuminance value of the plurality of illuminance values included in each cluster; and identifying the representative illuminance value corresponding to each cluster based on the plurality of illuminance values to which the weight value applies, wherein a larger weight value is applied to the illuminance value obtained on a later date among the plurality of dates.

The identifying corresponding to each cluster may include: obtaining an arithmetic mean of the plurality of illuminance values to which the weight value applies and identifying the representative illuminance value corresponding to each cluster.

The method may include: based on a difference between each illuminance value of the plurality of illuminance values obtained the preset number of times and the identified representative illuminance value being greater than or equal to the preset threshold value, transmitting an alarm related to the illuminance sensor to an electronic device.

The method may include: based on a difference between the obtained illuminance value and the identified representative illuminance value being smaller than the preset threshold value, controlling the brightness of the display based on the obtained illuminance value.

The method may include: based on a difference between the obtained illuminance value and the identified representative illuminance value being smaller than the preset threshold value, deleting the illuminance value obtained on a fastest date among the plurality of illuminance values obtained at a same time as a present time when the illuminance value is obtained through the illuminance sensor during the plurality of dates from the memory, storing the illuminance value obtained through the illuminance sensor in the memory, and updating the plurality of illuminance values corresponding to the time when the illuminance value is obtained through the illuminance sensor.

### BRIEF DESCRIPTION OF THE DRAWINGS

The above and other aspects and/or features of embodiments of the disclosure will be more apparent from the following description taken in conjunction with the accompanying drawings, in which:

FIG. 1 is a view illustrating a display device according to an embodiment;

FIG. 2A is a block diagram illustrating an embodiment of a display device according to an embodiment;

FIG. 2B is a block diagram illustrating an embodiment of a display device according to an embodiment;

FIGS. 3, 4A, and 4B are views illustrating a method of obtaining a plurality of illuminance values during a plurality of dates to identify a representative illuminance value according to an embodiment;

FIG. 5 is a flow chart illustrating a method of controlling brightness of a display according to an embodiment;

FIG. 6 is a flow chart illustrating a method of controlling brightness of a display by using a representative illuminance value or an illuminance value obtained through an illuminance sensor according to an embodiment;

FIG. 7 is a view illustrating an embodiment of an alarm displayed in an electronic device according to an embodiment;

FIG. 8 is a flow chart illustrating a method of updating a plurality of illuminance values according to an embodiment; and

FIG. 9 is a flow chart illustrating a method of controlling brightness of a display device according to an embodiment.

### DETAILED DESCRIPTION

The term used in the disclosure is briefly described, and then the disclosure is specifically described.

The terms used in embodiments of the disclosure are selected as general terms which are currently widely used as much as possible in consideration of functions in the disclosure but may be varied depending on intention of those skilled in the art, a precedent, appearance of new technologies, or the like. Also, there is a term which is arbitrarily selected by the applicant in a certain case and in this case, its meaning is specifically described in the relevant description part of the disclosure. Therefore, the term used in the disclosure should be defined based on the meaning of the term and the entire content throughout the disclosure rather than simply the name of the term.

In the disclosure, the expression such as “have,” “may have,” “include”, or “may include” denotes the existence of such a characteristic (e.g. a numerical value, a function, an operation, or a component such as a part), and the expression does not exclude existence of an additional characteristic.

In the disclosure, the expression “A or B”, “at least one of A and/or B”, “one or more of A and/or B”, or the like may include all possible combinations of the listed items. For example, “A or B”, “at least one of A and B”, or “at least one of A or B” may refer to all of the following cases: (1) including at least one A, (2) including at least one B, or (3) including all of at least one A and at least one B.

The expression “1st”, “2nd”, “first”, “second”, or the like used in the disclosure may be used to describe various elements regardless of any order and/or degree of importance, wherein the expression is used only to distinguish one element from another element and is not intended to limit the elements.

The description that one element (e.g. a first element) is “(operatively or communicatively) coupled with/to” or “connected to” another element (e.g. a second element) should be interpreted to include both the case where the one element is directly coupled to the another element, and the case where the one element is coupled to the another element through the other element (e.g. a third element).

The expression “configured to (or set to)” used in the disclosure may be interchangeably used with other expressions, for example, “suitable for”, “having the capacity to”, “designed to”, “adapted to”, “made to”, or “capable of” depending on circumstances. The term “configured to (or set to)” may not necessarily mean “specifically designed to” in terms of hardware.

Under some circumstances, the expression “a device configured to” may mean that the device “is capable of”′ performing an operation together with another device or component. For example, the phrase “a processor configured to (set to) perform A, B, and C” may mean a dedicated processor for performing the corresponding operations (e.g. an embedded processor), or a generic-purpose processor that may perform the corresponding operations by executing one or more software programs stored in a memory device (e.g. a CPU or an application processor).

A singular expression includes a plural expression, unless obviously differently defined in the context. In the application, the term such as “include” or “consist of” should be construed as designating that there are such characteristics, numbers, steps, operations, components, parts, or a combination thereof described in the specification but not as excluding in advance possibility of the existence or addition of one or more other characteristics, numbers, steps, operations, components, parts, or a combination thereof.

In embodiments, a “module” or “part” may perform at least one function or operation and may be implemented as hardware or software, or as a combination of hardware and software. Also, a plurality of “modules” or “parts” may be integrated into at least one module and implemented as at least one processor (not shown), excluding a “module” or a “part” that needs to be implemented as specific hardware.

Various elements and areas in the drawings are illustrated schematically. Accordingly, the technical idea of the disclosure is not limited by the relative sizes or intervals illustrated in the appended drawings.

Hereinafter, an embodiment of the disclosure is more specifically described with reference to the appended drawings.

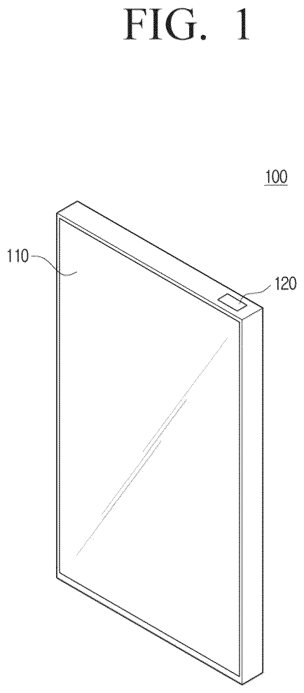

FIG. 1 is a view illustrating a display device according to an embodiment.

With reference to FIG. 1, a display device 100 may be installed outdoors. For example, the display device 100 may be installed in various outdoor places such as a vacant lot, a park, an exterior wall of a building, and a rooftop of a building.

The display device 100 may detect illuminance around the display device 100 by using an illuminance sensor 120 and automatically control brightness of a display 110 according to the detected illuminance.

For example, the display device 100 may control brightness of the display 110 such that the higher illuminance around the display device 100 is, the brighter the display 110 is, and may control brightness of the display 110 such that the lower illuminance around the display device 100 is, the darker the display 110 is. That is, the display device 100 may set a screen dark in a dark environment and set the screen bright in a relatively bright environment.

Because the display device 100 is installed outdoors, when illuminance around the display device 100 is detected by using the illuminance sensor 120, there may be a case that an inaccurate illuminance value is detected by the illuminance sensor 120 due to an effect resulting from an outside factor. In this case, brightness of the display 110 may be controlled not to match a surrounding environment due to the inaccurate illuminance value.

For example, in case that there is a tree around the display device 100, if the illuminance sensor 120 is covered by a leaf hanging from the tree or a leaf fallen from the tree, or the illuminance sensor 120 is covered by an animal such as a bird, an illuminance value lower than an illuminance value corresponding to surrounding brightness of the display device 100 may be detected by the illuminance sensor 120. Here, if the display device 100 controls brightness of the display 110 based on the detected illuminance value, the brightness of the display 110 may be excessively darkly adjusted compared to the surrounding brightness.

To prevent this problem, the display device 100 according to an embodiment of the disclosure may compare an illuminance value detected in a present time zone to an illuminance value detected in the same time zone of the past and control brightness of the display 110 based on a comparison result.

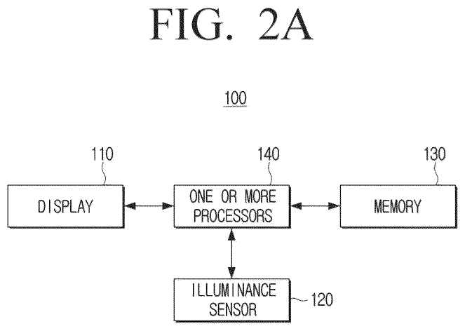

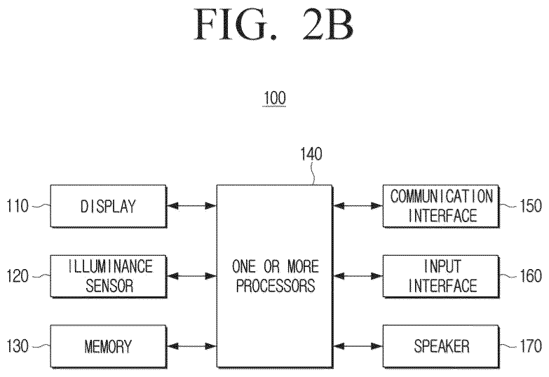

FIG. 2A is a block diagram illustrating an embodiment of a display device according to an embodiment.

With reference to FIG. 2A, the display device 100 may include a display 110, an illuminance sensor 120, memory 130, and one or more processors 140.

The display 110 may display an image. For the above, the display 110 may be realized as various types of displays such as a LCD, a LED, or an OLED. Also, the display 110 may be implemented as a flat display, a curved display, a foldable and/or rollable flexible display, etc.

The illuminance sensor 120 may detect illuminance around the display device 100. For the above, the illuminance sensor 120 may be arranged in a housing of the display device 100. Further, the illuminance sensor 120 may detect an illuminance value around the display device 100 and transmit a signal corresponding to the measured illuminance value to one or more processors 140.

For example, the illuminance sensor 120 may be implemented as any one of a photo sensor, a cadmium sulfide (CDS) sensor, an ultra violet (UV) sensor, or an ambient light sensor (ALS) but is not limited thereto.

The memory 130 may store data required for operating the display device 100 according to various embodiments of the disclosure.

The memory 130 may be implemented as memory embedded in the display device 100 according to a use for data storage or may be implemented as memory detachable from the display device 100.

For example, memory embedded in the display device 100 may be implemented as at least one of volatile memory (e.g. dynamic RAM (DRAM), static RAM (SRAM), or synchronous dynamic RAM (SDRAM)) or non-volatile memory (e.g. one time programmable ROM (OTPROM), programmable ROM (PROM), erasable and programmable ROM (EPROM), electrically erasable and programmable ROM (EEPROM), mask ROM, or flash ROM, flash memory (e.g. NAND flash memory or NOR flash memory), a hard drive, or a solid state drive (SSD)).

In a case of memory detachable from the display device 100, the memory 130 may be implemented as a memory card (e.g. a compact flash (CF) card, a secure digital (SD) card, a micro secure digital (Micro-SD) card, a mini secure digital (Mini-SD) card, an extreme digital (xD) card, a multi-media card (MMC), etc.), external memory connectable to a USB port (e.g. USB memory), etc.

Also, the memory 130 may store one or more instructions. In this case, one or more processors 140 may perform operations of the display device 100 according to various embodiments of the disclosure by executing one or more instructions stored in the memory 130. Also, the memory 130 may store a program and data for driving the display device 100. Further, the memory 130 may store various software programs and various applications for operating the display device 100.

The one or more processors 140 control the display device 100 overall. Specifically, the one or more processors 140 may be connected to each component of the display device 100 to control operations of the display device 100 overall. For example, the one or more processors 140 may be connected to the display 110, the illuminance sensor 120, and the memory 130 to control the display device 100. The one or more processors 140 may be implemented as one processor or a plurality of processors.

The one or more processors 140 may perform operations of the display device 100 according to various embodiments of the disclosure by executing one or more instructions stored in the memory 130.

The one or more processors 140 may include one or more of a Central Processing Unit (CPU), a Graphics Processing Unit (GPU), an Accelerated Processing Unit (APU), a Many Integrated Core (MIC), a Digital Signal Processor (DSP), a Neural Processing Unit (NPU), a hardware accelerator, or a machine learning accelerator. The one or more processors 140 may control one or any combination of other components of the display device 100 and perform an operation related to communication or data processing. The one or more processors 140 may perform one or more programs or instructions stored in the memory. For example, the one or more processors may perform a method according to an embodiment of the disclosure by executing one or more instructions stored in the memory.

If a method according to an embodiment of the disclosure includes a plurality of operations, the plurality of operations may be performed by one processor and may be performed by a plurality of processors. For example, when a first operation, a second operation, and a third operation are performed by a method according to an embodiment, all of the first operation, the second operation, and the third operation may be performed by a first processor and also, the first operation and the second operation are performed by the first processor (e.g. a general purpose processor) and the third operation may be performed by a second processor (e.g. an AI-dedicated processor).

The one or more processors 140 may be implemented as a single core processor including one core and may be implemented as one or more multi core processors including a plurality of cores (e.g. homogeneous multicores or heterogeneous multicores). If the one or more processors 140 are implemented as a multi core processor, each of the plurality of cores included in the multi core processor may include processor internal memory such as cache memory and on-chip memory, wherein a common cache shared by the plurality of cores may be included in the multi core processor. Also, each of the plurality of cores included in the multi core processor (or part of the plurality of cores) may read and perform program instructions for independently implementing a method according to an embodiment of the disclosure and also, may read and perform program instructions for implementing a method according to an embodiment of the disclosure in connection with all (or part) of the plurality of cores.

If a method according to an embodiment of the disclosure includes a plurality of operations, the plurality of operations may be performed by one core among the plurality of cores included in the multi core processor and may be performed by the plurality of cores. For example, when a first operation, a second operation, and a third operation are performed by a method according to an embodiment, all of the first operation, the second operation, and the third operation may be performed by a first core included in the multi core processor and also, the first operation and the second operation may be performed by the first core included in the multi core processor and the third operation may be performed by the second core included in the multi core processor.

In embodiments of the disclosure, a processor may mean a System on Chip (SoC) onto which one or more processors and other electronic components are integrated, a single core processor, a multi core processor, or a core included in the single core processor or the multi core processor, wherein the core may be implemented as a CPU, a GPU, an APU, a MIC, a DSP, a NPU, a hardware accelerator, a machine learning accelerator, or the like, but embodiments of the disclosure are not limited thereto.

FIG. 2B is a block diagram illustrating an embodiment of a display device according to an embodiment.

With reference to FIG. 2B, the display device 100 may include a display 110, an illuminance sensor 120, memory 130, one more processors 140, a communication interface 150, an input interface 160, and a speaker 170. However, the above configuration is merely exemplary, wherein it is obvious that upon implementing the disclosure, a new configuration may be added to the above configuration, or part of the configuration may be omitted. Meanwhile, the detailed description of components overlapped with the components shown in FIG. 2A among the components shown in FIG. 2B is omitted.

The communication interface 150 may include circuitry. The communication interface 150 is a component performing communication with an external device. For example, the one or more processors 140 may transmit various data to an external device through the communication interface 150 and receive various data from the external device.

For the above, the communication interface 150 may support various communication methods. For example, the communication interface 150 may perform communication with the external device through a communication method such as mobile communication, for example, 3G, LTE, and 5G, AP-based Wi-Fi (Wi-Fi, a Wireless LAN network), a wired/wireless Local Area Network (LAN), a Wide Area Network (WAN), Ethernet, IEEE 1394, Bluetooth (BT), Bluetooth Low Energy (BLE), a High-Definition Multimedia Interface (HDMI), a Universal Serial Bus (USB), a Mobile High-Definition Link (MHL), Audio Engineering Society/European Broadcasting Union (AES/EBU), an Optical communication method, or a Coaxial communication method. Here, the external device may include an electronic device such as a PC, a mobile phone, or a tablet. Also, the communication interface 150 may perform communication with an external storage medium (e.g. USB memory), an external server (e.g. a cloud server), etc.

The input interface 160 may receive a user command. For the above, the input interface 160 may include at least one button. For example, the one or more processors 140 may control various operations such as power on/off of the display device 100 based on a user command received through the input interface 160.

The speaker 170 may output audio sound. For example, the one or more processor 140 may convert audio sound received through the communication interface 150 or audio sound stored in the memory 130 to an audio signal and may output the audio signal through the speaker 170.

Below, for convenience of the description, the one or processors 140 are referred to as a processor 140.

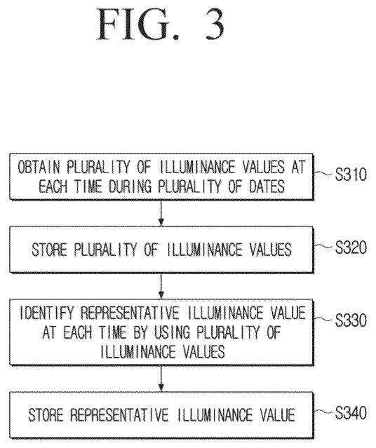

FIG. 3 is a flow chart illustrating a method of obtaining a plurality of illuminance values during a plurality of dates to identify a representative illuminance value according to an embodiment.

With reference to FIG. 3, the processor 140 may obtain a plurality of illuminance values at each time during a plurality of dates by using the illuminance sensor 120 (S310) and may store the obtained plurality of illuminance values in the memory 130 (S320).

Here, the plurality of dates are a preset time section and as an example, they may be 30 days but are not limited thereto.

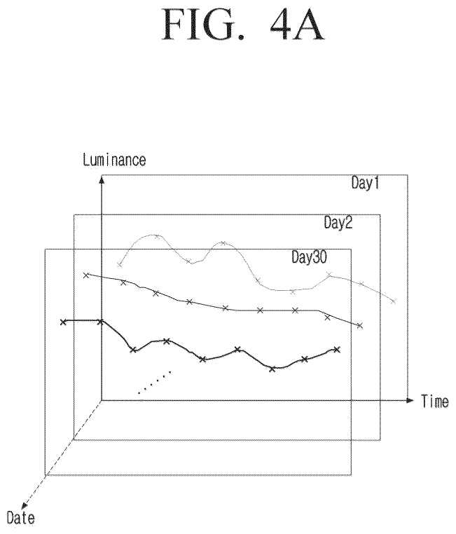

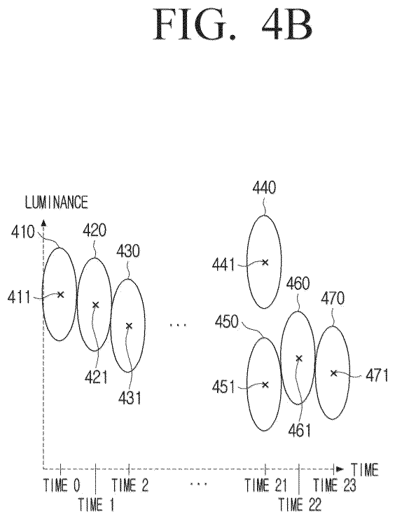

For example, as shown in FIG. 4A, the processor 140 may detect illuminance around the display device 100 through the illuminance sensor 120 at each time (e.g. a time of 0, 1, 2, . . . , 23) during a day to obtain a plurality of illuminance values. Further, the processor 140 may store the plurality of obtained illuminance values in memory 130. The processor 140 may perform this process over 30 days (e.g. Day 1, Day 2, . . . , Day 30), obtain a plurality of illuminance values at each time for 30 days, and store the obtained plurality of illuminance values in the memory 130.

For the above, the memory 130 may include a clock module (not shown) for measuring a time and a date. In this case, the clock module (not shown) is a software module and may be operated by the processor 140.

The processor 140 may detect illuminance around the display device 100 through the illuminance sensor 120 at each time zone for a day. Here, the time zone may include, for example, times of 0 to 00:30, 1 to 01:30, . . . , 23 to 23:30.

Further, the processor 140 may identify a representative illuminance value at each time based on a plurality of illuminance values obtained at each time during a plurality of dates (S330), and store the identified representative illuminance value in the memory 130 (S340).

Specifically, the processor 140 may cluster the plurality of illuminance values obtained at each time as at least one cluster based on the plurality of illuminance values obtained at each time during the plurality of dates.

In this case, the processor 140 may cluster the plurality of illuminance values obtained at each time during the plurality of dates by using a clustering algorithm. For example, the clustering algorithm may be a K-Means clustering algorithm or a K-Medians clustering algorithm. Meanwhile, it is not limited to this example and various clustering algorithms may be used.

Further, the processor 140 may identify a representative illuminance value corresponding to each cluster based on the plurality of illuminance values included in each of the at least one cluster corresponding to the each time.

For example, the processor 140 may calculate (e.g., obtain) a representative illuminance value corresponding to each cluster through an arithmetic mean of the plurality of illuminance values included in each cluster.

Specifically, the processor 140 may apply a weight value based on a date when each of the plurality of illuminance values included in the each cluster is obtained to each of the plurality of illuminance values included in the each cluster, and identify a representative illuminance value corresponding to the each cluster based on the plurality of illuminance values to which the weight value applies. Here, a relatively larger weight value may be applied to an illuminance value obtained on a relatively later date among the plurality of dates.

In this case, the processor 140 may calculate an arithmetic mean of the plurality of illuminance values to which the weight value applies and identify a representative illuminance value corresponding to each cluster.

For example, it is assumed that a plurality of illuminance values obtained at a time of 0 for 30 days (e.g. Day 1, Day 2, . . . , Day 30) are clustered into one cluster.

In this case, the processor 140 may apply a weight value w₁ to an illuminance value l₁ detected on Day 1, apply a weight value w₂ to an illuminance value l₂ detected on Day 2, . . . , and apply a weight value w₃₀ to an illuminance value 130 detected on Day 30. Here, the weight value may be w₁<w₂< . . . <w₃₀. Further, the processor 140 may identify a value of dividing a total sum of illuminance values to which weight values apply by the number of illuminance values included in the cluster (e.g. (l₁×w₁+l₂×w₂+ . . . +l₃₀×w₃₀)/30) as a representative illuminance value of the cluster at a time of 0.

By using this way, the processor 140 may identify a representative illuminance value of each of at least one cluster corresponding to each time and store the identified representative illuminance value in the memory 130.

For example, as shown in FIG. 4B, the processor 140 may identify a representative illuminance value of a cluster 410 at a time of 0 (110) (411), a representative illuminance value of a cluster 420 at a time of 1 (lᵣ₁) (421), a representative illuminance value of a cluster 430 at a time of 2 (lᵣ₃) (431), . . . , representative illuminance values of clusters 440, 450 at a time of 21 (lᵣ₂₁₋₁, lᵣ₂₁₋₂) (441, 451), a representative illuminance value of a cluster 460 at a time of 22 (lᵣ₂₂) (461), and a representative illuminance value of a cluster 470 at a time of 23 (lᵣ₂₃) (471).

Accordingly, the memory 130 may store information about a plurality of illuminance values obtained at each time during a plurality of dates and a representative illuminance value obtained based on the plurality of illuminance values obtained at the each time.

Specifically, the processor 140 may adjust brightness of the display 110 according to surrounding brightness of the display device 100.

For the above, the memory 130 may store information about a plurality of brightness values of the display 110 corresponding to the plurality of illuminance values. The processor 140 may control brightness of the display 110 by using a brightness value corresponding to an illuminance value among a plurality of brightness value stored in the memory 130. In this case, the lower the illuminance value is, the darker brightness of the display 110 may be set to be, and the higher the illuminance value is, the brighter brightness of the display 110 may be set to be based on the plurality of brightness values stored in the memory 130.

An illuminance value used for controlling brightness of the display 110 may be a representative illuminance value or an illuminance value detected at a present time through the illuminance sensor 120.

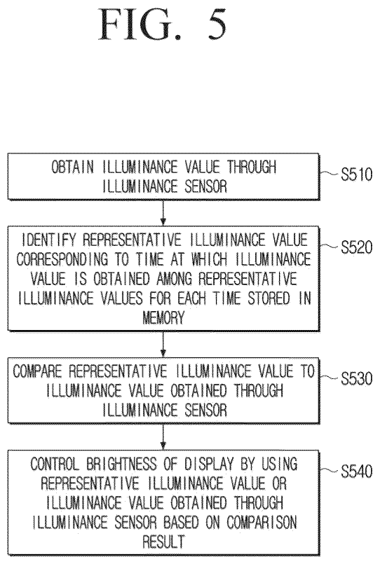

FIG. 5 is a flow chart illustrating a method of controlling brightness a display according to an embodiment.

With reference to FIG. 5, the processor 140 obtains an illuminance value through an illuminance sensor 120. In this case, the processor 140 may detect illuminance around a display device 100 through the illuminance sensor 120 at the same time as a time when an illuminance value is obtained during a plurality of past dates to obtain an illuminance value.

Further, the processor 140 may identify a representative illuminance value corresponding to a time at which the illuminance value is obtained among the representative illuminance values for the each time stored in the memory 130 (S520), and compare the representative illuminance value to the illuminance value obtained through the illuminance sensor 120 (S530).

For example, it is assumed that an illuminance value is obtained at a time of 0, 1, 2, . . . , 23 for 30 days. In this case, the memory 130 may store a plurality of illuminance values obtained at each time for 30 days and a representative illuminance value of each time.

In this case, the processor 140 may obtain an illuminance value through the illuminance sensor 120 at a time of 0 on Day 31. Further, the processor 140 may obtain a representative illuminance value at the time of 0 for 30 days among representative illuminance values by time for 30 days (e.g. a representative illuminance value at a time of 0, a representative illuminance value at a time of 1, . . . , a representative illuminance value at a time of 23) and may compare the representative illuminance value at the time of 0 for 30 days to the illuminance value detected at the time of 0 on Day 31.

Further, the processor 140 may control brightness of the display 110 by using a representative illuminance value or an illuminance value obtained through the illuminance sensor 120 based on a comparison result (S540).

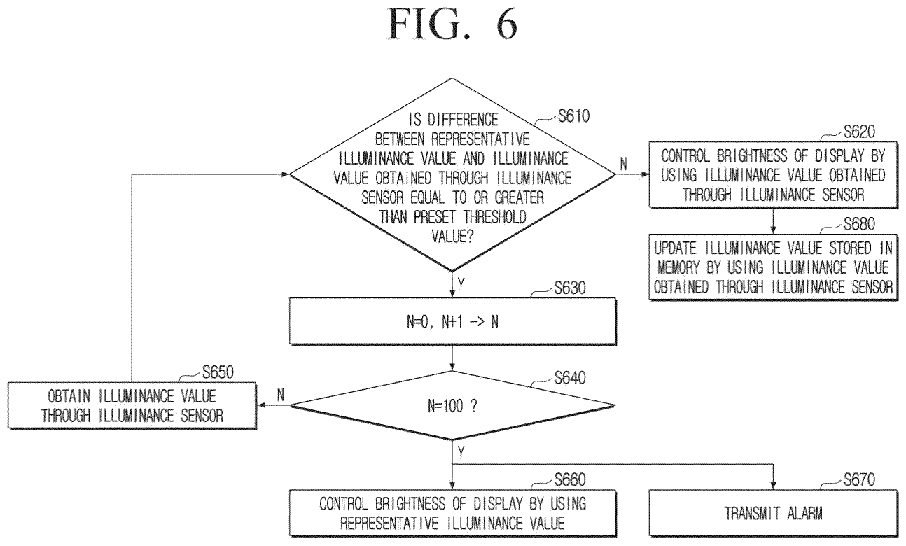

FIG. 6 is a flow chart illustrating a method of controlling brightness of a display by using a representative illuminance value or an illuminance value obtained through an illuminance sensor according to an embodiment.

With reference to FIG. 6, a processor 140, if a difference between a representative illuminance value and an illuminance value obtained through an illuminance sensor 120 is smaller than a preset threshold value (S610-N), may control brightness of a display 110 based on an illuminance value obtained through the illuminance sensor 120 (S620). Here, the preset threshold value may be 100 lux. Meanwhile, it is not limited to this example, and the preset threshold value may be set to various values. The preset threshold value may be set in a step of manufacturing the display device 100 and may be changed according to a user command. That is, the processor 140 may identify a brightness value corresponding to an illuminance value obtained at a present time through the illuminance sensor 120 among the plurality of brightness values stored in the memory 130 and control brightness of the display 110 by using the identified brightness value.

The processor 140, if a difference between the representative illuminance value and the illuminance value obtained through the illuminance sensor 120 is equal to or greater than the preset threshold value (S610-Y), may obtain an illuminance value again through the illuminance sensor 120 and compare the illuminance value to the representative illuminance value. Further, the processor 140, if a difference between each of a plurality of illuminance values obtained a preset number of times and the representative illuminance value is equal to or greater than the preset threshold value, may control brightness of the display 110 based on the representative illuminance value. Here, the preset number of times may be 100. Meanwhile, it is not limited to this example, and the preset number of times may be set to various values. The preset number of times may be set in a step of manufacturing the display device 100 and may be changed according to a user command.

Specifically, the processor 140, if a difference between the representative illuminance value and the illuminance value obtained through the illuminance sensor 120 is equal to or greater than the preset threshold value (S610-Y), may update a value n (n=0) to n+1→n (S630) and identify whether the value n is 100 (S640).

The processor 140, if identifying that the value n is not 100 (S640-N), may detect illuminance around the display device 100 again through the illuminance sensor 120 and obtain an illuminance value from the illuminance sensor 120 (S650).

Further, the processor 140 may compare the representative illuminance value to the illuminance value obtained through the illuminance sensor 120 (S610). The processor 140, if a difference between the representative illuminance value and an illuminance value obtained by detecting illuminance around the display 110 again through the illuminance sensor 120 is smaller than the preset threshold value (S610-N), may control brightness of the display 110 by using the illuminance value obtained through the illuminance sensor 120 (S620).

However, the processor 140, if a difference between the representative illuminance value and the illuminance value obtained by detecting illuminance around the display 110 again through the illuminance sensor 120 is equal to or greater than the preset threshold value (S610-Y), may reupdate the value n (n=0) (S630) and identify whether the value n is 100 (S640). Here, the processor 140, if an illuminance value of which a difference from the representative illuminance value before the value n is 100 is smaller than the preset threshold value is detected through the illuminance sensor 120, may control brightness of the display 110 by using the illuminance value detected through the illuminance sensor 120.

The processor 140, if an illuminance value of which a difference from the representative illuminance value until the value n is 100 is equal to or greater than the preset threshold value is continuously detected through the illuminance sensor 120, may control brightness of the display 110 by using the representative illuminance value (S660). That is, the processor 140 may identify a brightness value corresponding to a representative illuminance value among the plurality of brightness values stored in the memory 130 and control brightness of the display 110 by using the identified brightness value.

The processor 140, if a difference between each of a plurality of illuminance values obtained a preset number of times and the representative illuminance value is equal to or greater than the preset threshold value, may transmit an alarm related to the illuminance sensor 120 to an electronic device through the communication interface 150 (S670).

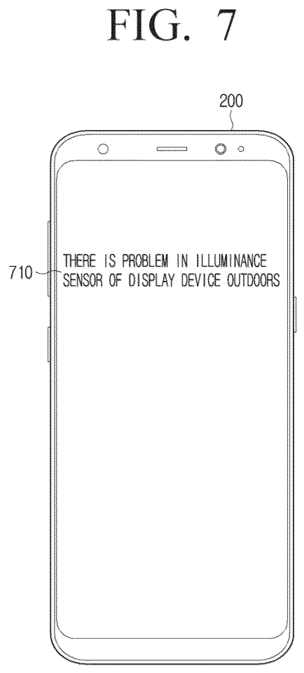

In this case, the electronic device may display the alarm received from the display device 100 on a display of the electronic device. Here, the alarm may include a message for indicating that there is a problem in the illuminance sensor 102. For example, as shown in FIG. 7, an alarm 710 such as “there is a problem in the illuminance sensor of the display device outdoors” may be displayed on an electronic device 200. Here, the electronic device may include a PC, a mobile phone, or a tablet of a user who uses the display device 100.

The processor 140, if a difference between the representative illuminance value and the illuminance value obtained through the illuminance sensor 120 is smaller than the preset threshold value, may update the plurality of illuminance values stored in the memory 130 (S670).

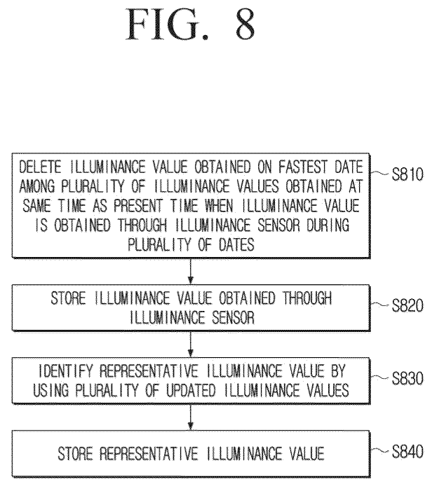

FIG. 8 is a flow chart illustrating a method of updating a plurality of illuminance values according to an embodiment.

A processor 140 may delete an illuminance value obtained on the fastest date among the plurality of illuminance values obtained during the plurality of dates at the same time as a present time when an illuminance value is obtained through an illuminance sensor 120 from memory 130 (S810), store the illuminance value obtained through the illuminance sensor 120 in the memory 130 (S820), and update the plurality of illuminance values corresponding to the present time when the illuminance value is obtained through the illuminance sensor 120.

For example, it is assumed that a difference between an illuminance value obtained through the illuminance sensor 120 at a time of 0 on Day 31 and a representative illuminance value at the time of 0 for the past 30 days is equal to or less than a preset threshold value. In this case, the processor 140 may delete an illuminance value obtained on the fastest date, Day 1, among the plurality of illuminance values obtained at the time of 0 for 30 days from the memory 130, store the illuminance value obtained through the illuminance sensor 120 at the time of 0 on Day 31 in the memory 130, and update the plurality of illuminance values obtained at the time of 0.

Further, the processor 140 may identify a representative illuminance value based on the plurality of updated illuminance values (S830), and store the representative illuminance value in the memory 130 (S840).

For example, the processor 140 may identify a representative illuminance value at a time of 0 based on a plurality of illuminance values obtained at the time of 0 on Day 2 to Day 31 and store the representative illuminance value at the time of 0 in the memory 130. In this case, the processor 140 may delete a representative illuminance value at the time of 0 stored in the memory 130 (i.e. a representative illuminance value at the time of 0 identified based on the plurality of illuminance values obtained at the time of 0 on Day 1 to Day 30). As above, the processor 140 may also update the representative illuminance value as the plurality of illuminance values are updated. A method of identifying a representative illuminance value is the same as the aforementioned method, and thus the detailed description thereof is omitted.

The processor 140 may detect illuminance around the display 110 through the illuminance sensor 120 at a next time to obtain an illuminance value and may compare the obtained illuminance value to a representative illuminance value of the next time. Further, the processor 140 may control brightness of the display 110 by using the representative illuminance value or the illuminance value obtained through the illuminance sensor 120 based on a comparison result and may update the plurality of illuminance values obtained at the next time during the plurality of past dates.

For example, the processor 140 may obtain an illuminance value through the illuminance sensor 120 at a time of 1 on Day 31. Further, the processor 140 may obtain a representative illuminance value at the time of 1 for 30 days among representative illuminance values by time for 30 days (e.g. a representative illuminance value at a time of 0, a representative illuminance value at a time of 1, . . . , a representative illuminance value at a time of 23) and may compare the representative illuminance value at the time of 1 for 30 days to the illuminance value detected at the time of 1 on Day 31.

Further, the processor 140 may control brightness of the display 110 by using the representative illuminance value at the time of 1 for 30 days or the illuminance value detected at the time of 1 on Day 31 based on a comparison result.

Specifically, the processor 140, if a difference between the representative illuminance value at the time of 1 for 30 days and the illuminance value detected at the time of 1 on Day 31 is smaller than a preset threshold value, may control brightness of the display 110 by using the illuminance value detected at the time of 1 on Day 31. Further, the processor 140 may update a plurality of illuminance values detected at the time of 1 for 30 days by using the illuminance value detected at the time of 1 on Day 31 and update the representative illuminance value at the time of 1 by using the plurality of updated illuminance values. Meanwhile, the processor 140, an illuminance value of which a difference from the representative illuminance value at the time of 1 for 30 days is equal to or greater than the preset threshold value is continuously detected at the time of 1 on Day 31 (e.g. in case of being continuously detected 100 times), may control brightness of the display 110 by using the representative illuminance value at the time of 1 for 30 days.

As above, the processor 140 may obtain an illuminance value through the illuminance sensor 120 every hour, compare the illuminance value to the representative illuminance value, and control brightness of the display 110.

As aforementioned, according to the disclosure, the display device 100 may compare an illuminance value detected at a present time through the illuminance sensor 120 to an illuminance value detected at the past and may control brightness of the display 110 based on a comparison result. Here, the display device 100 does not simply compare illuminance values by date but compares an illuminance value detected at a present time zone through the illuminance sensor 120 to a representative illuminance value at the same time zone of the past in consideration of a surrounding environment by time in an area and a location where the display device 100 is installed. Here, because the representative illuminance value is calculated by applying a relatively high weight value to an illuminance value obtained at a date relatively close to a present date, it may be a value in which a current surrounding environment is more considered.

Also, the reason that there is a large difference between an illuminance value detected at a present time point through the illuminance sensor 120 and a representative illuminance value at the same time zone of the past is stochastically because there is a problem in the illuminance sensor 120. Therefore, the display device 100, if a difference between the illuminance value detected at the present time point through the illuminance sensor 120 and the representative illuminance value at the same time zone of the past is equal to or greater than a preset threshold value, may identify that there is a problem in the illuminance sensor 120, control brightness of the display 110 by using the representative illuminance value, and provide the problem of the illuminance sensor 120 to a user through an alarm.

Here, the problem incurred in the illuminance sensor 120 may mean that the illuminance sensor 120 is broken or the illuminance sensor 120 is continuously covered by an obstacle. For example, a problem that the illuminance sensor 120 is covered by a leaf or a bird may be naturally resolved as a time is elapsed such that wind blows away the leaf or the bird flies over. Therefore, the display device 100 may identify whether the problem incurred in the illuminance sensor 120 is a problem that is temporarily incurred. Specifically, the display device 100, if a difference between the illuminance value detected at the present time point through the illuminance sensor 120 and the representative illuminance value at the same time zone of the past is equal to or greater than a preset threshold value, identifies whether an illuminance value of which a difference from the representative illuminance value is equal to or greater than the preset threshold value is continuously detected through the illuminance sensor 120 until the preset number of times. Accordingly, in the disclosure, brightness of the display 110 may be more efficiently controlled by using an illuminance value detected by the illuminance sensor 120.

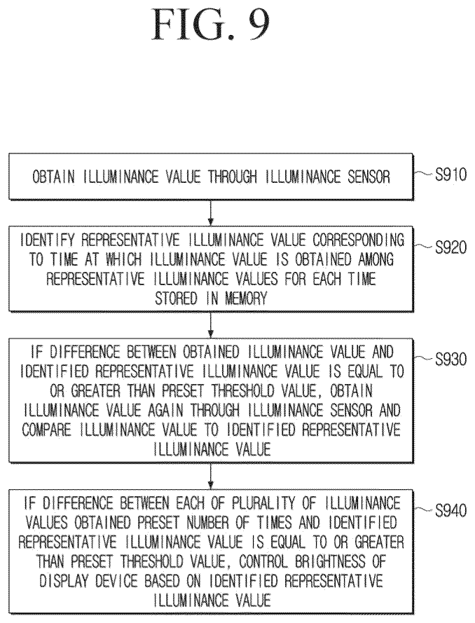

FIG. 9 is a flow chart illustrating a method of controlling brightness of a display device according to an embodiment.

The method includes obtaining an illuminance value through an illuminance sensor (S910).

Further, the method includes identifying a representative illuminance value corresponding to a time at which the illuminance value is obtained among representative illuminance values for each time stored in the memory (S920). Here, the representative illuminance values for each time stored in the memory may be values identified based on a plurality of illuminance values obtained at each time during a plurality of dates.

Further, the method includes, if a difference between the obtained illuminance value and the identified representative illuminance value is equal to or greater than a preset threshold value, obtaining an illuminance value again through the illuminance sensor and comparing the illuminance value to the identified representative illuminance value (S930).

Further, the method includes, if a difference between each of a plurality of illuminance values obtained a preset number of times and the identified representative illuminance value is equal to or greater than the preset threshold value, controlling brightness of the display based on the identified representative illuminance value (S940).

The method includes clustering the plurality of illuminance values obtained at the each time as at least one cluster based on the plurality of illuminance values obtained at the each time, identifying a representative illuminance value corresponding to each cluster based on the plurality of illuminance values included in each of the at least one cluster corresponding to the each time, and storing the identified representative illuminance value in the memory.

Also, the method includes applying a weight value based on a date when each of the plurality of illuminance values included in the each cluster is obtained to each of the plurality of illuminance values included in the each cluster, and identifying a representative illuminance value corresponding to the each cluster based on the plurality of illuminance values to which the weight value applies. Here, a relatively larger weight value may be applied to an illuminance value obtained on a relatively later date among the plurality of dates.

Further, the method includes calculating an arithmetic mean of the plurality of illuminance values to which a weight value applies and identifying a representative illuminance value corresponding to each cluster.

Also, the method includes, if a difference between each of a plurality of illuminance values obtained a preset number of times and the identified representative illuminance value is equal to or greater than the preset threshold value, transmitting an alarm related to the illuminance sensor to an electronic device.

Further, the method includes, if a difference between the obtained illuminance value and the identified representative illuminance value is smaller than the preset threshold value, controlling brightness of the display based on the obtained illuminance value.

Also, the method includes, if a difference between the obtained illuminance value and the identified representative illuminance value is smaller than the preset threshold value, deleting an illuminance value obtained on the fastest date among a plurality of illuminance values obtained at the same time as a present time when an illuminance value is obtained through the illuminance sensor during the plurality of dates from the memory, storing an illuminance value obtained through the illuminance sensor in the memory, and updating a plurality of illuminance values corresponding to a time when the illuminance value is obtained through the illuminance sensor.

Further, the method includes identifying a representative illuminance value based on the updated plurality of illuminance values and storing the identified representative illuminance value in the memory.

According to an embodiment of the disclosure, various examples described above may be implemented as software including instructions stored in a machine (e.g. computer) readable storage medium. The machine refers to a device which calls instructions stored in the storage medium and is operable according to the called instructions, wherein the machine may include an electronic device (e.g. an electronic device A) according to the disclosed embodiments. If the instructions are executed by a processor, the processor may perform a function corresponding to the instructions directly or by using other components under control of the processor. The instructions may include a code generated or executed by a compiler or an interpreter. A machine readable storage medium may be provided in a form of a non-transitory storage medium. Here, the term ‘non-transitory’ merely means that the storage medium does not include a signal and is tangible, wherein the term does not distinguish a case that data is stored in the storage medium semipermanently from a case that data is stored in the storage medium temporarily.

Also, according to an embodiment of the disclosure, the method according to various examples described above may be provided to be included in a computer program product. The computer program product may be traded between a seller and a buyer as goods. The computer program product may be distributed in a form of a machine readable storage medium (e.g. compact disc read only memory (CD-ROM)) or may be on-line distributed via an application store (e.g. Play store™). In the case of on-line distribution, at least part of the computer program product may be stored at least temporarily or may be generated temporarily in a storage medium such as memory of a server of a manufacturer, a server of an application store, or a relay server.

Also, according to an embodiment of the disclosure, various embodiments described as above may be implemented in a recording medium that may be read by a computer or a device similar thereto by using software, hardware, or a combination thereof. In some cases, the embodiments described in the specification may be implemented as a processor itself. According to software implementation, the embodiments such as procedures and functions described in the specification may be also implemented as separate software. Each software may perform one or more functions and operations described in the specification.

Computer instructions for performing the processing operation of the machine according to the various embodiments above may be stored in a non-transitory computer readable medium. The computer instructions stored in this non-transitory computer readable medium, when executed by a processor of a specific device, causes the specific device to perform a processing operation of the device according to the various embodiments. The non-transitory computer readable medium does not mean a medium that stores data for a short time such as a resistor, a cache, memory, or the like but means a machine readable medium that stores data semipermanently. A specific example of the non-transitory computer readable medium may be a CD, a DVD, a hard disk, a Blu-ray disk, a USB, a memory card, ROM, etc.

Also, each of components (e.g. a module or a program) according to the various embodiments above may be configured as a single item or a plurality of items, wherein a partial subcomponent of the aforementioned relevant subcomponents may be omitted, or another subcomponent may be further included in various embodiments. Mostly or additionally, some components (e.g. a module or a program) may be integrated into one item and may identically or similarly perform a function implemented by each of the relevant components before the integration. According to various embodiments, operations performed by a module, a program, or another component may be executed sequentially, in parallel, repetitively, or heuristically, or at least part of the operations may be executed in different orders or be omitted, or another operation may be added.

As the above, examples of the present disclosure are shown and described. However, it is obvious that the disclosure is not limited to the aforementioned specific examples, and various modifications may be implemented by those skilled in the art without deviating from the gist of the disclosure claimed in the scope of claims, wherein these modifications should not be independently understood from the technical spirit or prospect of the disclosure.

What is claimed is:

1. A display device comprising:
a display;
an illuminance sensor;
memory that stores at least one instruction, information about a plurality of illuminance values obtained at each time during a plurality of dates, and a plurality of representative illuminance values obtained based on the plurality of illuminance values obtained at each time; and
one or more processors,
wherein the at least one instruction, when executed by the one or more processors individually or collectively, cause the display device to:
obtain an illuminance value through the illuminance sensor;
identify a representative illuminance value corresponding to the time at which the illuminance value is obtained among the plurality of representative illuminance values for each time stored in the memory;
based on a difference between the obtained illuminance value and the identified representative illuminance value being greater than or equal to a preset threshold value, obtain another illuminance value through the illuminance sensor and compare the another illuminance value to the identified representative illuminance value; and
based on a difference between each illuminance value of the plurality of illuminance values obtained a preset number of times and the identified representative illuminance value being greater than or equal to the preset threshold value, control a brightness of the display based on the identified representative illuminance value.

2. The display device of claim 1, wherein the at least one instruction, when executed by the one or more processors, cause the display device to:
cluster the plurality of illuminance values obtained at each time as at least one cluster based on the plurality of illuminance values obtained at each time;
identify the representative illuminance value corresponding to each cluster based on the plurality of illuminance values included in each cluster of the at least one cluster corresponding to each time; and
store the identified representative illuminance value in the memory.

3. The display device of claim 2, wherein the at least one instruction, when executed by the one or more processors, cause the display device to:
apply a weight value based on a date when each illuminance value of the plurality of illuminance values included in each cluster is obtained to each illuminance value of the plurality of illuminance values included in each cluster;
identify the representative illuminance value corresponding to each cluster based on the plurality of illuminance values to which the weight value applies; and
apply a larger weight value to the illuminance value obtained on a later date among the plurality of dates.

4. The display device of claim 3, wherein the at least one instruction, when executed by the one or more processors, cause the display device to:
obtain an arithmetic mean of the plurality of illuminance values to which the weight value applies and identify the representative illuminance value corresponding to each cluster.

5. The display device of claim 1, further comprising:
a communication interface,
wherein the at least one instruction, when executed by the one or more processors, cause the display device to:
based on a difference between each illuminance value of the plurality of illuminance values obtained the preset number of times and the identified representative illuminance value being greater than or equal to the preset threshold value, transmit an alarm related to the illuminance sensor to an electronic device through the communication interface.

6. The display device of claim 1, wherein the at least one instruction, when executed by the one or more processors, cause the display device to:
based on a difference between the obtained illuminance value and the identified representative illuminance value being smaller than the preset threshold value, control the brightness of the display based on the obtained illuminance value.

7. The display device of claim 1, wherein the at least one instruction, when executed by the one or more processors, cause the display device to:
based on a difference between the obtained illuminance value and the identified representative illuminance value being smaller than the preset threshold value, delete the illuminance value obtained on a fastest date among the plurality of illuminance values obtained at a same time as a present time when the illuminance value is obtained through the illuminance sensor during the plurality of dates from the memory, store the illuminance value obtained through the illuminance sensor in the memory, and update the plurality of illuminance values corresponding to the time when the illuminance value is obtained through the illuminance sensor.

8. The display device of claim 7, wherein the at least one instruction, when executed by the one or more processors, cause the display device to:
identify the representative illuminance value based on the updated plurality of illuminance values and store the identified representative illuminance value in the memory.

9. A method of controlling a brightness of a display device including a display, an illuminance sensor, and memory, the method comprising:
obtaining an illuminance value through the illuminance sensor;
identifying a representative illuminance value corresponding to a time at which the illuminance value is obtained among representative illuminance values for each time stored in the memory;
based on a difference between the obtained illuminance value and the identified representative illuminance value being greater than or equal to a preset threshold value, obtaining another illuminance value through the illuminance sensor and comparing the another illuminance value to the identified representative illuminance value; and
based on a difference between each illuminance value of a plurality of illuminance values obtained a preset number of times and the identified representative illuminance value being greater than or equal to the preset threshold value, controlling the brightness of the display based on the identified representative illuminance value,
wherein the representative illuminance values for each time stored in the memory are values identified based on the plurality of illuminance values obtained for each time during a plurality of dates.

10. The method of claim 9, further comprising:
clustering the plurality of illuminance values obtained at each time as at least one cluster based on the plurality of illuminance values obtained at each time;
identifying the representative illuminance value corresponding to each cluster based on the plurality of illuminance values included in each cluster of the at least one cluster corresponding to each time; and
storing the identified representative illuminance value in the memory.

11. The method of claim 10, wherein the identifying corresponding to each cluster includes:
applying a weight value based on a date when each illuminance value of the plurality of illuminance values included in each cluster is obtained to each illuminance value of the plurality of illuminance values included in each cluster; and
identifying the representative illuminance value corresponding to each cluster based on the plurality of illuminance values to which the weight value applies,
wherein a larger weight value is applied to the illuminance value obtained on a later date among the plurality of dates.

12. The method of claim 11, wherein the identifying corresponding to each cluster includes:
obtaining an arithmetic mean of the plurality of illuminance values to which the weight value applies and identifying the representative illuminance value corresponding to each cluster.

13. The method of claim 9, further comprising:
based on a difference between each illuminance value of the plurality of illuminance values obtained the preset number of times and the identified representative illuminance value being greater than or equal to the preset threshold value, transmitting an alarm related to the illuminance sensor to an electronic device.

14. The method of claim 9, further comprising:
based on a difference between the obtained illuminance value and the identified representative illuminance value being smaller than the preset threshold value, controlling the brightness of the display based on the obtained illuminance value.

15. The method of claim 9, further comprising:
based on a difference between the obtained illuminance value and the identified representative illuminance value being smaller than the preset threshold value, deleting the illuminance value obtained on a fastest date among the plurality of illuminance values obtained at a same time as a present time when the illuminance value is obtained through the illuminance sensor during the plurality of dates from the memory, storing the illuminance value obtained through the illuminance sensor in the memory, and updating the plurality of illuminance values corresponding to the time when the illuminance value is obtained through the illuminance sensor.

16. A non-transitory computer readable recording medium storing computer instructions for a display device to perform an operation when executed by one or more processor of the display device which comprises a display, an illuminance sensor and memory, wherein the operation comprises;
obtaining an illuminance value through the illuminance sensor;
identifying a representative illuminance value corresponding to a time at which the illuminance value is obtained among representative illuminance values for each time stored in the memory;
based on a difference between the obtained illuminance value and the identified representative illuminance value being greater than or equal to a preset threshold value, obtaining another illuminance value through the illuminance sensor and comparing the another illuminance value to the identified representative illuminance value; and
based on a difference between each illuminance value of a plurality of illuminance values obtained a preset number of times and the identified representative illuminance value being greater than or equal to the preset threshold value, controlling the brightness of the display based on the identified representative illuminance value,
wherein the representative illuminance values for each time stored in the memory are values identified based on the plurality of illuminance values obtained for each time during a plurality of dates.

17. A non-transitory computer readable recording medium of claim 16, further comprising:
clustering the plurality of illuminance values obtained at each time as at least one cluster based on the plurality of illuminance values obtained at each time;
identifying the representative illuminance value corresponding to each cluster based on the plurality of illuminance values included in each cluster of the at least one cluster corresponding to each time; and
storing the identified representative illuminance value in the memory.

18. A non-transitory computer readable recording medium of claim 17, wherein the identifying corresponding to each cluster includes:
applying a weight value based on a date when each illuminance value of the plurality of illuminance values included in each cluster is obtained to each illuminance value of the plurality of illuminance values included in each cluster; and
identifying the representative illuminance value corresponding to each cluster based on the plurality of illuminance values to which the weight value applies,
wherein a larger weight value is applied to the illuminance value obtained on a later date among the plurality of dates.

19. A non-transitory computer readable recording medium of claim 18, wherein the identifying corresponding to each cluster includes:
obtaining an arithmetic mean of the plurality of illuminance values to which the weight value applies and identifying the representative illuminance value corresponding to each cluster.

20. A non-transitory computer readable recording medium of claim 16, further comprising:
based on a difference between each illuminance value of the plurality of illuminance values obtained the preset number of times and the identified representative illuminance value being greater than or equal to the preset threshold value, transmitting an alarm related to the illuminance sensor to an electronic device.
